(19) United States
(12) Patent Application Publication
(10) Pub. No.: US 2025/0374050 A1
(43) Pub. Date: Dec. 4, 2025

(54) COMMUNICATION SYSTEM, TERMINAL DEVICE, COMMUNICATION DEVICE, CERTIFICATE AUTHORITY, AND METHOD

(71) Applicant: KABUSHIKI KAISHA TOSHIBA, Tokyo (JP)

(72) Inventors: Toshio ITO, Yokohama (JP); Yasuyuki TANAKA, Kawasaki (JP)

(73) Assignee: KABUSHIKI KAISHA TOSHIBA, Tokyo (JP)

(21) Appl. No.: 19/058,177

(22) Filed: Feb. 20, 2025

(30) Foreign Application Priority Data
May 31, 2024 (JP) 2024-089070

(51) Int. Cl. H04W 12/069; H04W 12/0431; H04W 12/08

(52) U.S. Cl. CPC H04W 12/069; H04W 12/0431; H04W 12/08

(57) ABSTRACT

According to one embodiment, a communication device sends a device authorization request and device information to a certificate authority. The certificate authority sends access information, user code and a device code to the communication device. The communication device sends the access information and the user code to a terminal device. The terminal device requests issuance of an access token to the certificate authority based on the device information in association with the user code. The communication device sends the certificate signing request and the access token to the certificate authority. The certificate authority issues the certificate.

### CROSS-REFERENCE TO RELATED APPLICATIONS

This application is based upon and claims the benefit of priority from Japanese Patent Application No. 2024-089070, filed May 31, 2024, the entire contents of which are incorporated herein by reference.

### FIELD

Embodiments described herein relate generally to a communication system, a terminal device, a communication device, a certificate authority, and a method.

### BACKGROUND

In the technology known as the Internet of Things (IoT), various IoT services can be realized by connecting edge devices (communication devices) to a network.

In order for the edge device mentioned above to communicate with an application server device which provides IoT services via the network, a certificate to ensure security for the communication (for example, a certificate for a public key of the edge device in public key cryptography) is necessary but, for example, much labor is required to issue the certificate on the user side who owns the edge device.

### BRIEF DESCRIPTION OF THE DRAWINGS

FIG. 1 is a view showing an example of a system configuration of a communication system according to a first embodiment.

FIG. 2 is a view showing an example of a functional configuration of an edge device.

FIG. 3 is a table showing an example of device information.

FIG. 4 is a view showing an example of a functional configuration of a user terminal.

FIG. 5 is a table showing an example of user information.

FIG. 6 is a view showing an example of server information.

FIG. 7 is a view showing an example of a functional configuration of a certificate authority.

FIG. 8 is a view showing an example of the hardware configuration of the edge device.

FIG. 9 is a sequence chart showing an example of a procedure of a communication system.

FIG. 10 is a table showing an example of device authorization session information.

FIG. 11 is a table showing an example of verification information.

FIG. 12 is a table showing another example of the verification information.

FIG. 13 is a view showing an example of a device confirmation screen.

FIG. 14 is a table showing an example of issuance history information.

FIG. 15 is a view illustrating an example of a specific usage of the communication system.

FIG. 16 is a view showing an example of a system configuration of a communication system according to a second embodiment.

FIG. 17 is a view showing an example of a functional configuration of an edge device.

FIG. 18 is a view showing an example of a functional configuration of a verification server device.

FIG. 19 is a view showing an example of a functional configuration of a certificate authority.

FIG. 20 is a sequence chart showing an example of a procedure of a communication system.

### DETAILED DESCRIPTION

In general, according to one embodiment, a communication system includes a communication device, a terminal device, and a certificate authority. The communication device is configured to send a device authorization request requesting authorization of the communication device and device information on the communication device to the certificate authority. The certificate authority is configured to send access information for accessing the certificate authority, and a user code and a device code managed in association with the device information, to the communication device, in response to the device authorization request. The communication device is configured to send the access information and the user code to the terminal device. The terminal device is configured to send the user code to the certificate authority by accessing the certificate authority based on the access information. The certificate authority is configured to send the device information managed in association with the user code to the terminal device. The terminal device is configured to request issuance of an access token by sending the user code to the certificate authority, based on the device information. The certificate authority is configured to issue an access token managed in association with the user code, in response to the request from the terminal device. The communication device is configured to request acquisition of an access token by sending the device code to the certificate authority. The certificate authority is configured to send an access token managed in association with the device code to the communication device, in response to the request from the communication device. The communication device is configured to send a certificate signing request for requesting issuance of a certificate used to execute communication with an application server device and the access token to the certificate authority. The certificate authority is configured to issue the certificate based on the certificate signing request and the access token.

Various embodiments will be described with reference to the accompanying drawings.

### First Embodiment

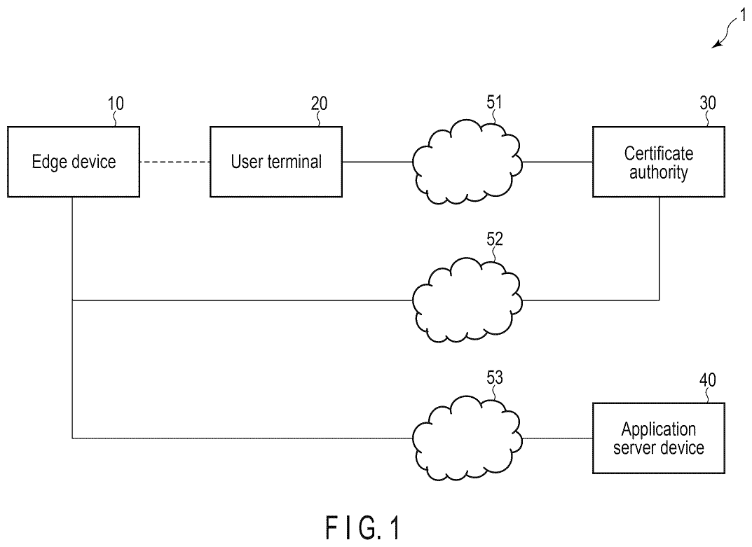

First, a first embodiment will be described. FIG. 1 shows an example of a system configuration of a communication system according to the embodiment. As shown in FIG. 1, a communication system 1 includes an edge device 10, a user terminal (client terminal) 20, a certificate authority 30, and an application server device 40.

The edge device 10 is a device used in technology referred to as IoT, and is equipped with a host controller configured to control the operation of the edge device 10 and a communication device configured to provide a communication function to the edge device 10.

Incidentally, for example, the host controller and the communication device are connected via a connection interface provided in the edge device 10 such as a USB connector or a pin slot connector. For example, however, serial communication such as I2C, URT and SPI or parallel communication may be executed between the host controller and the communication device.

In the embodiment, the edge device 10 may be simply referred to as a communication device, and includes IoT devices, personal computers (PC), gateways, or the like. The edge device 10 is configured to operate as part of an application system for providing various IoT services by communicating with the application server device 40. However, in the embodiment, it is assumed that since the edge device 10 is in a factory default condition, settings necessary for communicating with the application server device 40 are not made. Incidentally, the edge device 10 in the factory default condition may be a device that has been used for other purposes in the past and then returned to the factory default condition (i.e., initialized) by executing a predetermined operation.

The user terminal 20 is assumed to be, for example, a handheld terminal such as a smartphone or a tablet terminal used by the user who owns the edge device 10, but may also be a terminal device of the other form such as a PC. The user terminal 20 includes a user interface which accepts user input and presents information to the user.

The certificate authority (certification apparatus) 30 is an information processing apparatus configured to issue certificates used by the edge device 10 to communicate with the application server device 40. More specifically, when public key cryptography is employed to ensure security in the communication executed between the edge device 10 and the application server device 40, the certificate authority 30 issues a certificate for a public key of the edge device 10 in the public key cryptography (i.e., a public key certificate of the edge device 10). When the public key certificate thus issued by the certificate authority 30 is registered in the edge device 10, the edge device 10 becomes able to communicate with the application server device 40 using the public key certificate.

The application server device 40 operates to provide various IoT services by communicating with the edge device 10. More specifically, for example, the application server device 40 may operate to register sensor data collected by the edge device 10 in the application server device 40 or may operate to issue commands to the edge device 10 and cause the edge device 10 to execute a predetermined process. Furthermore, the application server device 40 may send firmware or software which operates on the edge device 10 to the edge device 10 and instruct the edge device 10 to update the firmware or the software.

For example, the above-described processing of the application server device 40 may be executed on a server computer managed on-premises at a location such as a business office or may be executed on a virtual computer realized on the computer. In addition, the processing of the application server device 40 may be executed on a cloud substrate in a communication network or on the Internet provided by a cloud service provider or the like.

Incidentally, the communication method applied to the communication between the edge device 10 and the user terminal 20 shown in FIG. 1 may be a wireless communication method or a wired communication method.

Examples of wireless communication methods include Bluetooth (registered trademark), Wi-Fi (registered trademark), ZigBee (registered trademark), and infrared communication, but is not limited to these.

Examples of wired communication methods include Ethernet (registered trademark), serial communication using Universal Asynchronous Receiver Transmitter (UART), and Controller Area Network (CAN), but is not limited to these.

Incidentally, a mechanism for transmitting information between the edge device 10 and the user terminal 20 may be constructed. For example, in a case where the edge device 10 incorporates a display, transmission of the information may be realized by reading a two-dimensional code such as a QR code (registered trademark) displayed on the display, using a camera installed in the user terminal 20 such as a smartphone. Furthermore, the information transmission from the edge device 10 to the user terminal 20 may be realized via a human (user). For example, a human may read a character string displayed on the display mounted on the edge device 10 and input it to the user terminal 20.

The communication between the edge device 10 and the user terminal 20 in the embodiment is assumed to include the information transmission realized as described above. For this reason, in FIG. 1, the edge device 10 and the user terminal 20 are connected by a broken line, which is distinguished from the other connection lines.

In addition, the user terminal 20 and the certificate authority 30 shown in FIG. 1 are connected communicably with each other via a network 51. In addition, the edge device 10 and the certificate authority 30 shown in FIG. 1 are connected communicably with each other via a network 52. In addition, the edge device 10 and the application server device 40 shown in FIG. 1 are connected communicably with each other via a network 53.

The communication method applied to the communication between the user terminal 20 and the network 51, and the communication method applied to the communication between the edge device 10 and the networks 52 and 53, may be a wireless communication method or a wired communication method.

In addition, for example, the network 51 may be a small-scale, closed network such as a local area network (LAN), or a wide-area, closed network such as a wide area network (WAN), or an open network such as the Internet. In addition, the user terminal 30 executes communication based on, for example, Wi-Fi and cellular communication methods (such as LTE or 5G) to connect to the network 51, but may be configured to execute communication based on other standards. The network 51 has been described here, but the networks 52 and 53 are configured in the same manner. Incidentally, the above-described networks 51 to 53 may be different networks or the same network.

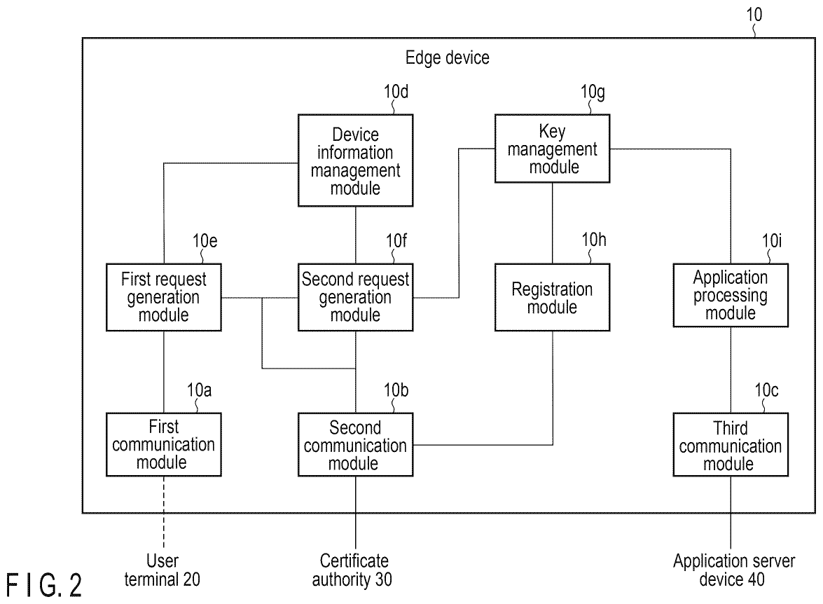

FIG. 2 shows an example of the functional configuration of the edge device 10 shown in FIG. 1. As shown in FIG. 2, the edge device 10 includes a first communication module 10a, a second communication module 10b, a third communication module 10c, a device information management module 10d, a first request generation module 10e, a second request generation module 10f, a key management module 10g, a registration module 10h, and an application processing module 10i.

The first communication module 10a executes communication with the user terminal 20 in accordance with a predetermined communication method. In addition, the second communication module 10b executes communication with the certificate authority 30 via the network 52. In addition, the third communication module 10c executes communication with the application server device 40 via the network 53.

Incidentally, in FIG. 2, the first to third communication modules 10a to 10c are shown as separate, independent functional modules, but the first to third communication modules 10a to 10c may be implemented as a single functional module. In addition, the communication method used by the first communication module 10a to execute communication, the communication method used by the second communication module 10b to execute communication, and the communication method used by the third communication module 10c to execute communication may be different from each other or may be the same as each other.

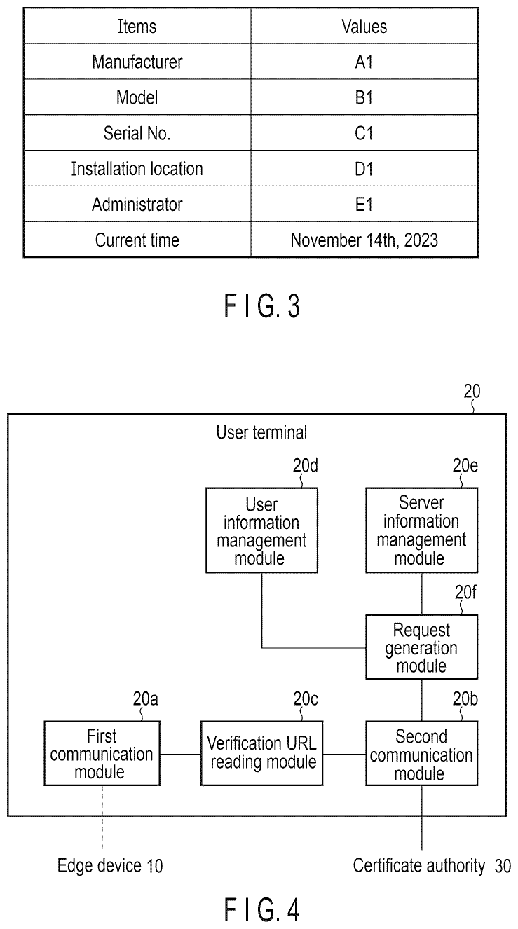

The device information management module 10d manages information on the edge device 10 (hereinafter referred to as device information). FIG. 3 shows an example of the device information. In the example shown in FIG. 3, the device information includes, for example, the manufacturer, model, serial number, installation location, administrator, and current time of the edge device 10.

The manufacturer, model, and serial number are, for example, information that is embedded in advance when the edge device 10 is manufactured (in other words, information that is registered in advance in the edge device 10). The installation location and the administrator are, for example, information provided by the user terminal 20 via the certificate authority 30. The current time is initialized by, for example, information provided by the certificate authority 30 and is automatically updated as elapse of the time.

In FIG. 3, it has been described that the device information includes the manufacturer, model, serial number, installation location, administrator, and current time. In the device information, however, some of elements of the information may be omitted or information other than the information (for example, model number, hardware version, and the like) may be included.

The first request generation module 10e generates a device authorization request to request the certificate authority 30 to authorize the edge device 10. The device authorization request generated by the first request generation module 10e is sent from the second communication module 10b to the certificate authority 30 together with the device information managed by the device information management module 10d.

The first request generation module 10e acquires the access information, the user code, and the device code sent from the certificate authority 30 in response to the device authorization request, via the second communication module 10b. Incidentally, the access information is information for accessing the certificate authority 30, and an example of the access information is a verification Uniform Resource Locator (URL) allocated to the certificate authority 30. The verification URL (access information) and the user code acquired by the first request generation module 10e are sent from the first communication module 10a to the user terminal 20.

The second request generation module 10f generates an access token acquisition request that requests the certificate authority 30 to acquire an access token. Incidentally, the access token corresponds to, for example, the authentication information issued by the certificate authority 30 to authenticate the device. The access token acquisition request generated by the second request generation module 10f is sent from the second communication module 10b to the certificate authority 30.

The second request generation module 10f acquires the access token sent from the certificate authority 30 in response to the above-described access token acquisition request, via the second communication module 10b. The second request generation module 10f generates a certificate signing request that requests the issuance of a public key certificate. The certificate signing request generated by the second request generation module 10f is sent from the second communication module 10b to the certificate authority 30 together with the access token.

The key management module 10g manages the public key and private key (key pair) of the edge device 10 in the public key cryptography. Incidentally, the certificate signing request generated by the above-described second request generation module 10f includes the public key of the edge device 10, which is managed by the key management module 10g.

In this example, the key pair of the edge device 10 may be generated in response to instructions from the second request generation module 10f, for example, when the second request generation module 10f generates the certificate signing request, and may also be generated, for example, when the power of the edge device 10 in a factory default state is turned on. In addition, the key pair of the edge device 10 may be stored in advance in the edge device 10. Furthermore, if the key management module 10g is implemented as a hardware security module such as a secure element, the key pair of the edge device 10 may be generated by the hardware.

It has been described that the key management module 10g mainly manages the key pair of the edge device 10. However, the key management module 10g may also execute cryptographic processing and signature processing based on the public key cryptography.

The registration module 10h executes a process of registering in the edge device 10 (key management module 10g) the public key certificate issued by the certificate authority 30 in response to the above-described certificate signing request.

The application processing module 10i uses the public key certificate registered in the edge device 10 to execute an authentication process (hereinafter referred to as device authentication process) for the edge device 10 with the application server device 40.

When the edge device 10 is authenticated (i.e., the authentication is successful) by executing the device authentication process, the application processing module 10i executes communication (application communication) with the server device 40 via the third communication module 10c. In addition, the application processing module 10i executes the processing on the edge device 10 side for providing IoT services (i.e., the application processing corresponding to the application communication). In this case, for example, the application processing module 10i may execute processing of acquiring sensor data from a sensor mounted on the edge device 10 and sending the sensor data to the application server device 40. In addition, the application processing module 10i may execute processing of executing commands on the edge device 10 or operating an actuator connected to the edge device 10 in accordance with instructions from the application server device 40. Furthermore, the application processing module 10i may execute processing of updating the firmware or software of the edge device 10 in accordance with instructions from the application server device 40.

FIG. 4 shows an example of a functional configuration of the user terminal 20 shown in FIG. 1. As shown in FIG. 4, the user terminal 20 includes a first communication module 20a, a second communication module 20b, a verification URL reading module 20c, a user information management module 20d, a server information management module 20e, and a request generation module 20f.

The first communication module 20a executes communication with the edge device 10 in accordance with a predetermined communication method. In addition, the second communication module 20b executes communication with the certificate authority 30 via the network 51.

Incidentally, in FIG. 4, the first and second communication modules 20a and 20b are shown as separate, independent functional modules. However, these first and second communication modules 20a and 20b may be implemented as a single functional module. In addition, the communication method used by the first communication module 20a to execute communication and the communication method used by the second communication module 20b to execute communication may be different from each other or may be the same as each other.

The verification URL reading module 20c acquires the verification URL and the user code sent from the edge device 10 via the first communication module 20a. The verification URL reading module 20c accesses the certificate authority 30 by reading the acquired verification URL. The user code acquired by the verification URL reading module 20c is thereby sent from the second communication module 20b to the certificate authority 30.

The user information management module 20d manages information (hereinafter referred to as user information) on the user who owns the edge device 10 (i.e., the user who uses the user terminal 20).

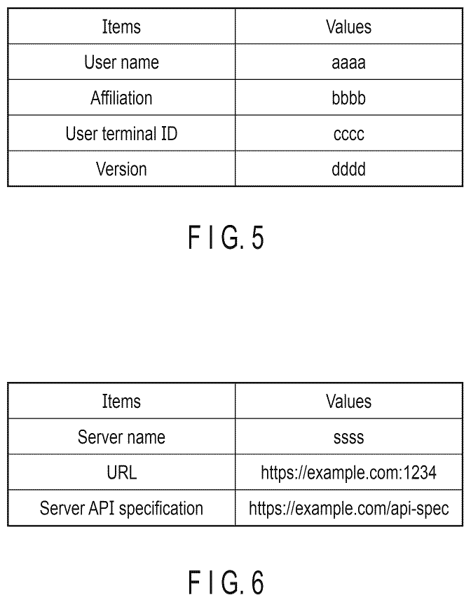

FIG. 5 shows an example of user information. As shown in FIG. 5, the user information includes, for example, the user's user name (user ID), the user's affiliation, the user terminal ID for identifying the user terminal 20, and the version of the user terminal 20.

The user name and the affiliation are, for example, information which is set by the user. The user terminal ID and the version are, for example, information that is embedded in advance at the time of manufacturing the user terminal 20 (in other words, information registered in advance in the user terminal 20).

Incidentally, in FIG. 5, it has been described that the user information includes the user name, affiliation, user terminal ID and version. In the user information, however, some elements of the information may be omitted or information other than these elements of information may be included.

The server information management module 20e manages information on the application server device 40 (hereinafter referred to as server information).

FIG. 6 shows an example of server information. As shown in FIG. 6, the server information includes, for example, the server name of the application server device 40, URL for accessing the application server device 40, and the specifications of Application Programming Interface (API) implemented in the application server device 40 (server API specifications).

The server name, the URL, and the server API specifications may be, for example, information set by the user, or information provided from the outside of the user terminal 20 (for example, application server device 40 or the like).

Incidentally, in FIG. 6, it has been described that the server information includes the server name, the URL, and the server API specifications. In the server information, however, some elements of the information may be omitted or information other than these elements of information may be included.

The request generation module 20f generates an access token issuance request which requests the certificate authority 30 to issue an access token. The access token issuance request generated by the request generation module 20f is sent from the second communication module 20b to the certificate authority 30 together with user-specified information.

Incidentally, the user-specified information corresponds to, for example, various elements of additional information that the user has input to the user terminal 20. The user-specified information may include some of the user information managed by the above-described user information management module 20d and the server information managed by the server information management module 20e.

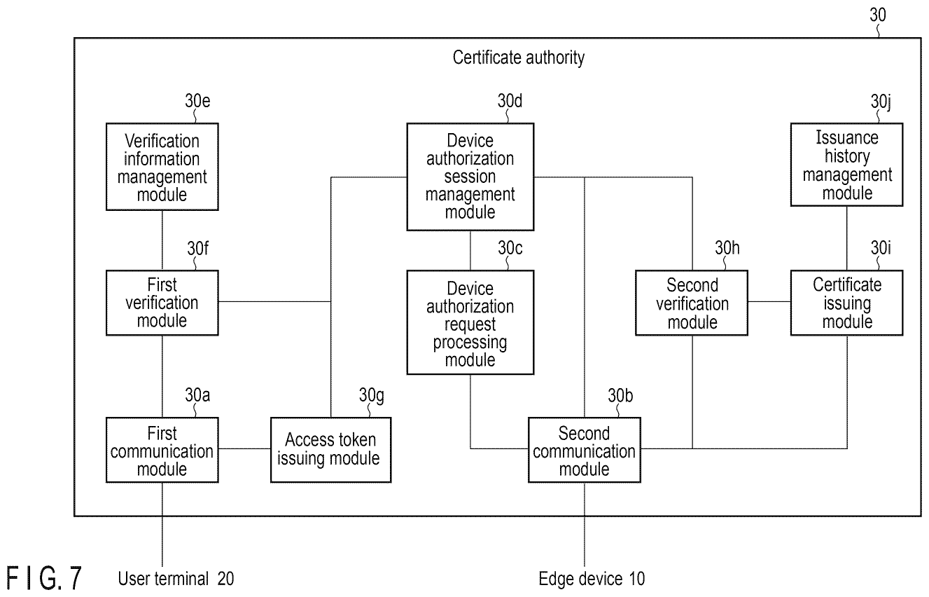

FIG. 7 shows an example of a functional configuration of the certificate authority 30 shown in FIG. 1. As shown in FIG. 7, the certificate authority 30 includes a first communication module 30a, a second communication module 30b, a device authorization request processing module 30c, a device authorization session management module 30d, a first verification module 30f, an access token issuing module 30g, a second verification module 30h, a certificate issuing module 30i, and an issuance history management module 30j.

The first communication module 30a executes communication with the user terminal 20 via the network 51. The second communication module 30b executes communication with the edge device 10 via the network 52.

Incidentally, in FIG. 7, the first and second communication modules 30a and 30b are shown as separate, independent functional modules. However, these first and second communication modules 30a and 30b may be implemented as a single functional module. In addition, the communication method used by the first communication module 30a to execute communication and the communication method used by the second communication module 30b to execute communication may be different from each other or may be the same as each other.

The device authorization request processing module 30c acquires the device authorization request and the device information sent from the edge device 10 via the second communication module 30b. The device authorization request processing module 30c processes the device authorization request and issues a user code and a device code for the device information.

The device authorization session management module 30d manages the user code, the device code, and the like issued by the device authorization request processing module 30c in association with the above-described device information. Incidentally, the information managed by the device authorization session management module 30d is referred to as device authorization session information. Incidentally, the device authorization session information includes various types of information in a range from the acquisition (receipt) of the device authorization request from the edge device 10 to the issuance of the public key certificate.

The verification information management module 30e manages information prepared in advance for verifying the user code (hereinafter referred to as verification information). The verification information includes, for example, information on the user's possession device which can issue the public key certificate.

The first verification module (user code verification module) 30f acquires the user code sent from the user terminal 20 via the first communication module 30a. The first verification module 30f executes verification of the user code, based on the verification information managed by the verification information management module 30e. In this case, the first verification module 30f verifies whether or not the user using the user terminal 20 has an authority to issue a certificate for the device associated (linked) with the user code. If the verification of the user code is successful, the first verification module 30f acquires the device information managed in association with the user code by the device authorization session management module 30d. The device information acquired by the first verification module 30f is sent from the first communication module 30a to the user terminal 20.

The access token issuing module 30g acquires the access token issuing request sent from the user terminal 20 via the first communication module 30a. The access token issuing module 30g issues an access token in response to the acquired access token issuing request. The access token issued by the access token issuing module 30g is managed by the device authorization session management module 30d. Incidentally, the access token is sent from the second communication module 30b to the edge device 10 in response to the access token acquisition request sent from the edge device 10.

The second verification module (request verification module) 30h acquires the certificate signing request sent from the edge device 10 via the second communication module 30b. The second verification module 30h executes verification of the certificate signing request, using the above-described device authorization session information (i.e., information managed by the device authorization session management module 30d).

If the verification of the certificate signing request is successful, the certificate issuing module 30i issues the public key certificate in response to the certificate signing request. The public key certificate issued by the certificate issuing module 30i is sent from the second communication module 30b to the edge device 10.

The issuance history management module 30j manages information on public key certificates issued in the past by the certificate issuing module 30i (hereinafter referred to as issuance history information). Whether or not the above-mentioned public key certificate need to be issued may be determined based on the issuance history information managed by the issuance history management module 30j (i.e., the history of the public key certificates issued in the past). Incidentally, the issuance history information managed by the issuance history management module 30j may be used, for example, to determine whether or not to issue an access token.

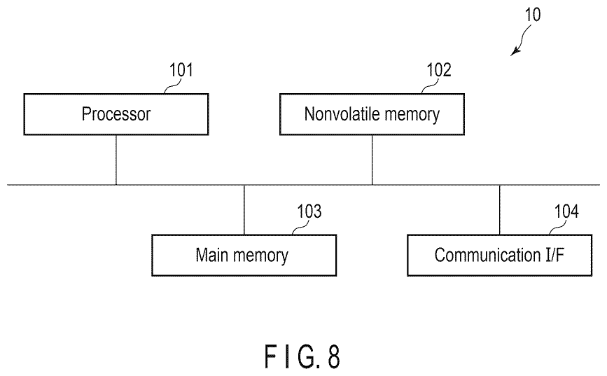

FIG. 8 shows an example of the hardware configuration of the above-described edge device 10. As shown in FIG. 8, the edge device 10 includes a processor 101, a nonvolatile memory 102, a main memory 103, a communication interface (I/F) 104, and the like.

The processor 101 is configured to control the operation of each component in the edge device 10 and may be, for example, a CPU or the like. In addition, the processor 101 may be a single processor or may be composed of multiple processors. The processor 101 runs various programs loaded from the nonvolatile memory 102 to the main memory 103. The communication interface 104 is, for example, an interface for realizing communication with the user terminal 20, the certificate authority 30, and the server device 40.

In the embodiment, some or all of the modules 10a to 10i shown in FIG. 2 may be realized by causing the processor 101 shown in FIG. 8 to run a predetermined program (application program) (i.e., software), by hardware such as an integrated circuit (IC), or by a configuration obtained by combining software and hardware.

The hardware configuration of the edge device 10 has been described, but it is assumed that the user terminal 20 and the certificate authority 30 also have substantially the same hardware configuration.

In this case, some or all of the modules 20a to 20f shown in FIG. 4 may be realized by causing the processor (CPU) of the user terminal 20 to run a predetermined program (i.e., software) or may be implemented by hardware, or may be realized by a configuration obtained by combining software and hardware.

In addition, some or all of the modules 30a to 30j shown in FIG. 7 may be realized by causing the processor (CPU) of the certificate authority 30 to run a predetermined program (i.e., software) or may be implemented by hardware, or may be realized by a configuration obtained by combining software and hardware.

Incidentally, in the embodiment, the user terminal 20 further includes an input device and a display device to realize the above-described user interface. In addition, the edge device 10 may further include, for example, a display device and the like, and the user terminal 20 may further include a camera and the like.

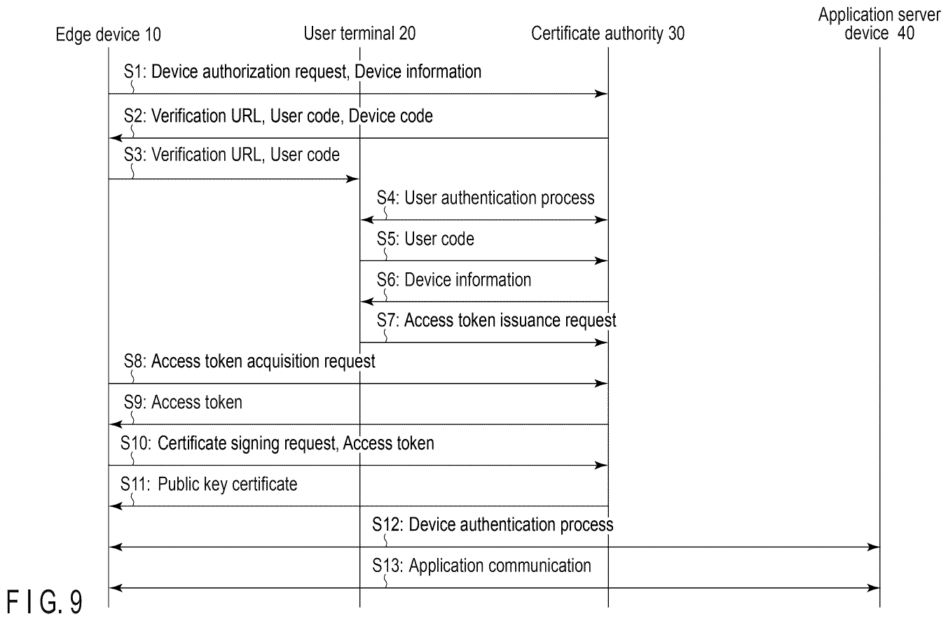

An example of the processing procedure of the communication system 1 according to the present embodiment will be described below with reference to a sequence chart of FIG. 9. Processing related to the initial settings of the edge device 10 which executes communication with the application server device 40 (initial setting sequence) will be mainly described.

Incidentally, in the embodiment, it is assumed that the edge device 10 is in the factory default state, and that at least a public key certificate used for the edge device 10 to communicate with the application server device 40 is not registered in the edge device 10. The communication system 1 according to the embodiment operates to realize issuance and registration of the public key certificate of the above-described edge device 10 using the user terminal 20.

First, for example, when the power of the edge device 10 in a factory default state is turned on, the first request generation module 10e included in the edge device 10 generates a device authorization request. Incidentally, the device authorization request is, for example, a device authorization request conforming to RFC 8628. The device authorization request may be generated at timing when, for example, the user presses (operates) a predetermined button provided on the edge device 10.

The first request generation module 10e sends the generated device authorization request and the device information (for example, manufacturer, model, serial number and the like of the edge device 10) managed by the device information management module 10d to the certificate authority 30 via the second communication module 10b (step S1). Incidentally, the information (for example, URL or the like) of the certificate authority 30, which is the destination of the device authorization request and the device information, may be written in advance or may be input by the user when the edge device 10 is manufactured.

When receiving the device authorization request and the device information sent from the edge device 10 in step S1, the device authorization request processing module 30c included in the certificate authority 30 newly issues the verification URL, the user code, and the device code. The verification URL is a URL which indicates a predetermined communication endpoint of the certificate authority 30, and is used for the user to access the certificate authority 30 using the user terminal 20, which will be described later. The user code and the device code are random character strings. Incidentally, since the user code may be manually input by the user, the user code is desirably a character string which is relatively easy to input (for example, a random six-digit numbers and the like). In addition, the device code is desirably a sufficiently long character string (for example, a random 50-digit alphanumeric characters and the like) to resist brute force attacks aimed at decrypting the code or illegally obtaining authentication information.

The device authorization request processing module 30c generates device authorization session information (i.e., a new entry of information managed by the device authorization session management module 30d).

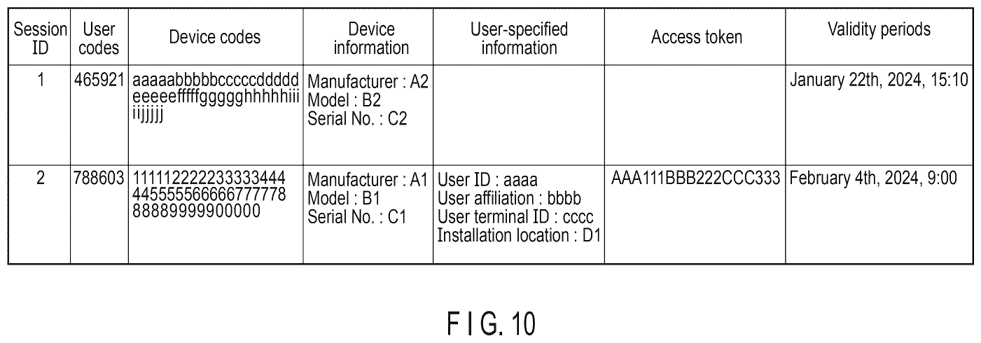

FIG. 10 shows an example of device authorization session information. As shown in FIG. 10, the device authorization session information includes a user code, a device code, device information, user-specified information, an access token, and a validity period in association with the identification information (session ID) allocated to the device authorization session information. Incidentally, the validity period is set when the device authorization session information is generated, and the device authorization session information whose expiration date has expired is discarded at predetermined timing.

Incidentally, the device authorization session information with session ID “1” and the device authorization session information with session ID “2” are shown in FIG. 10. The device authorization session information generated as a new entry by the device authorization request processing module 30c is empty for the user-specified information and the access token, similarly to the device authorization session information with session ID “1”.

As described above, the device authorization session information generated by the device authorization request processing module 30c is managed by the device authorization session management module 30d.

Next, the device authorization request processing module 30c sends the verification URL, user code, and device code issued as described above to the edge device 10 via the second communication module 30b (step S2).

When receiving the verification URL, the user code, and the device code sent from the certificate authority 30 in step S2, the first request generation module 10e included in the edge device 10 sends the verification URL and the user code to the user terminal 20 via the first communication module 10a (step S3). Incidentally, the device code is delivered from the first request generation module 10e to the second request generation module 10f.

It has been described that the verification URL and the user code are sent in step S3. In the embodiment, however, the verification URL and the user code may be sent from the edge device 10 to the user terminal 20. More specifically, the verification URL and the user code may be transmitted by a wireless communication method (Bluetooth, Wi-Fi, ZigBee, infrared communication, or the like) or a wired communication method (Ethernet, UART, CAN, or the like). For example, however, a QR code in which the verification URL and the user code are encoded may be displayed on the display (display device) mounted on the edge device 10, the QR code may be read by the camera mounted on the user terminal 20, and the verification URL and the user code may be thereby sent from the edge device 10 to the user terminal 20. Furthermore, the QR code in which the verification URL is encoded and the user code may be displayed on the display mounted on the edge device 10, the QR code may be read by the camera mounted on the user terminal 20, and the user code may be directly input to the user terminal 20 by the user who visually checks the user code.

When the process in step S3 is executed, the verification URL reading module 20c included in the user terminal 20 accesses the certificate authority 30, based on the verification URL received (transmitted) from the edge device 10.

Next, the user authentication process is executed between the user terminal 20 and the certificate authority 30 (step S4). The user authentication process corresponds to, for example, a process of sending the user ID, the password, and the like assigned to the user using the user terminal 20 from the user terminal 20 to the certificate authority 30, and confirming in the certificate authority 30 whether or not the user is a legitimate user who can request the issuance of the public key certificate. It has been described that the user ID and the password are used in the user authentication process. However, the user authentication process may be a process of authenticating the user (or the user terminal 20) or the other information may be used.

If the user is authenticated (i.e., user authentication is completed) by executing the process in step S4, the verification URL reading module 20c sends the user code sent (transmitted) from the edge device 10 as described above, to the certificate authority 30 via the second communication module 20b (step S5).

When receiving the user code sent from the user terminal 20 in step S5, the first verification module 30f included in the certificate authority 30 executes verification (i.e., verification of the user code) to determine whether or not the user can issue a certificate for the device linked to the user code. In this case, the first verification module 30f searches for device authorization session information includes the received user code (i.e., an entry corresponding to the user code), and acquires (reads) the searched device authorization session information from the device authorization session management module 30d. Next, the first verification module 30f compares the device authorization session information acquired from the device authorization session management module 30d with the verification information managed by the verification information management module 30e, and executes verification of the user code.

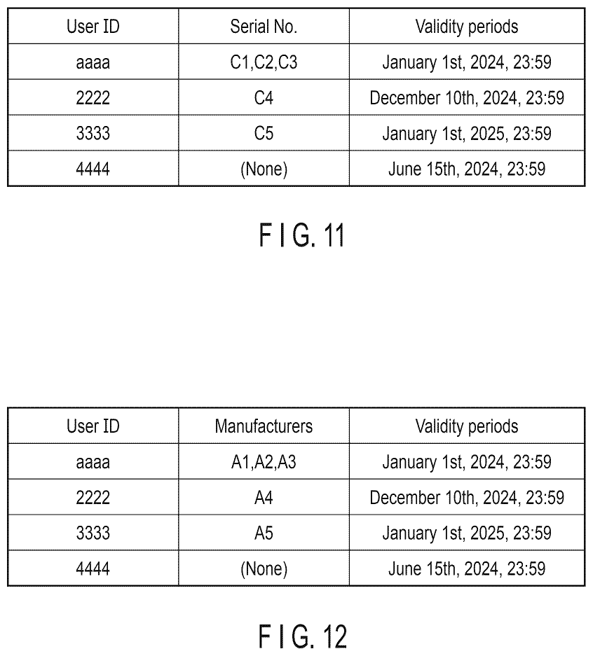

An example of the user code verification executed by the first verification module 30f will be described below. FIG. 11 shows an example of the verification information. In the example shown in FIG. 11, the verification information includes the user ID for identifying the user, the serial number of the edge device 10 owned by the user, and the validity period of the verification information in association with each other. The verification information (entries) that have expired may be discarded at predetermined timing or may be updated to entries including a new validity period.

The verification of the user code is successful when there is verification information including both the user ID used in the above-described user authentication and the serial number of the device information included in the device authorization session information acquired from the device authorization session management module 30d in association with each other (i.e., both the user ID and the serial number match the verification information). In contrast, the verification of the user code fails when there is no verification information including both the user ID and the serial number in association with each other (i.e., at least one of the user ID and the serial number does not match the verification information).

It has been described that the verification information is the information including the user ID and the serial number in association with each other. However, the verification information may also be, for example, information including the user ID and the manufacturer of the edge device 10 in association with each other as shown in FIG. 12. Even in the case of verification information as shown in FIG. 12, the verification of the user code can be executed similarly to the above-described verification information shown in FIG. 11.

Incidentally, the verification information managed by the verification information management module 30e may be information having a structure obtained by combining FIG. 11 and FIG. 12.

If the above-described verification of the user code is successful, the first verification module 30f sends to the user terminal 20 the device information included in the device authorization session information acquired from the above-described device authorization session management module 30d via the first communication module 30a (step S6).

Incidentally, if the user code verification fails, the first verification module 30f returns a message that the verification has failed (i.e., an error) to the user terminal 20 via the first communication module 30a.

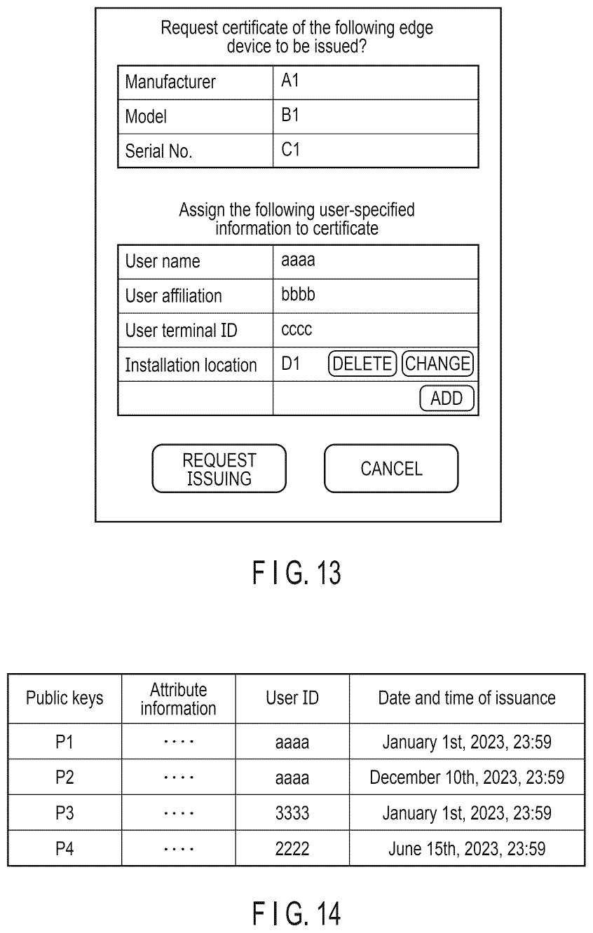

When the process in step S6 is executed, for example, the user terminal 20 displays the device information sent from the certificate authority 30 in step S6 on a screen as shown in FIG. 13 (hereinafter referred to as a device confirmation screen) and presents the device information to the user. According to this, the user can confirm whether or not the device information sent from the certificate authority 30 (i.e., the device information received by the user terminal 20) indicates the edge device 10 intended by the user. More specifically, for example, the user confirms whether the device information displayed (presented) on the device confirmation screen matches the device information (for example, the serial number and the like) printed on the housing of the edge device 10.

In addition, as shown in FIG. 13, additional information to be included in the public key certificate may be able to be confirmed or input on the device confirmation screen. The additional information thus confirmed or input on the device confirmation screen corresponds to the above-described user-specified information. In the example shown in FIG. 13, it is shown that the user name, user affiliation, user terminal ID, and installation location are included in the user-specified information. Incidentally, the user name, user affiliation, and user terminal ID are information acquired from the user information managed by the user information management module 20d, and cannot be edited (changed) on the device confirmation screen. In contrast, the installation location can be input by the user as information describing the location where the edge device 10 is installed. Incidentally, (the information of) the installation location may be automatically input (presented) from, for example, information on Global Positioning System (GPS), surrounding wireless LAN access points, or other wireless beacons.

Although not shown in FIG. 13, the user-specified information may include information acquired from the server information managed by the server information management module 20e. Furthermore, information (pairs of keys and values) input arbitrarily by the user may be added to the user-specified information.

As shown in FIG. 13, a “REQUEST ISSUING” button and a “CANCEL” button are provided on the device confirmation screen. If the “REQUEST ISSUING” button is specified (pressed) on the device confirmation screen by the user, the request generation module 20f generates an access token issuance request and sends the generated access token issuance request, together with the above-described user-specified information, to the certificate authority 30 via the second communication module 20b (step S7).

In contrast, if the “CANCEL” button is specified (pressed) on the device confirmation screen by the user, for example, issuing the public key certificate for the edge device 10 is canceled, and the processing shown in FIG. 9 is ended.

When receiving the access token issuing request and the user-specified information sent from the user terminal 20 in step S7, the access token issuing module 30g included in the certificate authority 30 issues a new access token. Incidentally, the access token issued by the access token issuing module 30g is, for example, a random character string.

The access token issued by the access token issuing module 30g and the user-specified information received by the access token issuing module 30g are delivered to the device authorization session management module 30d. For example, the above-described access token issuance request includes the user code, and the device authorization session management module 30d adds the access token and the user-specified information delivered from the access token issuance module 30g to the device authorization session information including the user code. As a result, the device authorization session information after the access token is issued is in a state where the access token and the user-specified information are added (embedded), similarly to the device authorization session information with session ID “2” as shown in FIG. 10.

When the above-described process in step S3 is executed, the first request generation module 10e included in the edge device 10 delivers the device code to the second request generation module 10f, and the second request generation module 10f operates to send the access token acquisition request including the device code to the certificate authority 30 via the second communication module 10b.

When receiving the access token acquisition request sent from the edge device 10 as described above, the device authorization session management module 30d included in the certificate authority 30 retrieves the device authorization session information (entry) which includes the device code included in the access token acquisition request. The device authorization session management module 30d confirms whether or not the access token is included in the retrieved device authorization session information. At the timing when the above-described process in step S7 is not executed (in other words, an access token is not issued), an access token is not included in the device authorization session information (in other words, the access token column is empty) and, therefore, the device authorization session management module 30d returns a message that an access token is not issued (in other words, a pending message) to the edge device 10, via the second communication module 30b. When receiving the pending message from the certificate authority 30, the second request generation module 10f included in the edge device 10 repeats an operation of waiting for a predetermined period of time and sending the access token acquisition request again (i.e., executing polling processing).

In contrast, it is assumed that an access token acquisition request is sent from the edge device 10 to the certificate authority 30 after the above-described process in step S7 is executed (step S8). In this case, the device authorization session management module 30d included in the certificate authority 30 receives the access token acquisition request sent from the edge device 10 and retrieves the device authorization session information which includes the device code included in the access token acquisition request. Since the process in step S7 is already executed, the access token is included in the device authorization session information thus retrieved. In this case, the device authorization session management module 30d acquires the access token included in the retrieved device authorization session information and sends the acquired access token to the edge device 10 via the second communication module 30b (step S9).

Incidentally, it has been described that the device authorization session information which includes the device code included in the access token acquisition request exists (i.e., the device authorization session information is managed by the device authorization session management module 30d). However, if the device authorization session information does not exist, an error is returned from the certificate authority 30 to the edge device 10. When receiving the error from the certificate authority 30, the second request generation module 10f included in the edge device 10 stops resending the access token acquisition request and the processing shown in FIG. 9 is ended.

When receiving the access token sent from the certificate authority 30 in step S9, the second request generation module 10f included in the edge device 10 generates a certificate signing request. The certificate signing request generated by the second request generation module 10f is, for example, a Certificate Signing Request (CSR) conforming to PKCS #10 (RFC2986) of the Public-Key Cryptography Standards (PKCS).

Incidentally, the certificate signing request includes the public key of the edge device 10, which is managed by the key management module 10g, but may further include device information (manufacturer, model, serial number, and the like of the edge device 10) managed by the device information management module 10d, the date and time when the certificate signing request is generated, and the like.

The second request generation module 10f sends the generated certificate signing request and the above-described access token to the certificate authority 30 via the second communication module 10b (step S10).

When receiving the certificate signing request and access token sent from the edge device 10 in step S10, the second verification module 30h included in the certificate authority 30 executes verification of the certificate signing request and the access token.

The verification of the certificate signing request and the access token will be described below. First, the second verification module 30h verifies whether or not the certificate signing request satisfies predetermined requirements. This verification succeeds if, for example, the public key included in the certificate signing request can be used with a specified cryptographic algorithm, and fails if the public key included in the certificate signing request cannot be used with a specified cryptographic algorithm.

In addition, the second verification module 30h verifies whether or not the device authorization session information (entry) including an access token exists. This verification succeeds if the device authorization session information including an access token is retrieved (i.e., acquired from the device authorization session management module 30d), and fails if the device authorization session information including the access token is not retrieved (i.e., is not acquired from the device authorization session management module 30d).

If the above-described verification of the certificate signing request or access token fails, the error is returned from the certificate authority 30 to the edge device 10.

In contrast, if the verifications of the certificate signing request and the access token are successful, the certificate issuing module 30i takes over the process from the second verification module 30h and issues the public key certificate for the edge device 10 in response to the certificate signing request delivered from the second verification module 30h. When the public key certificate is thus issued by the certificate issuing module 30i, the issuance history information for the issued public key certificate is managed by the issuance history management module 30j. In addition, the public key certificate for the edge device 10, which is issued by the certificate issuing module 30i, is sent to the edge device 10 via the second communication module 30b together with the user-specified information included in the device authorization session information acquired from the device authorization session management module 30d as described above (step S11).

Incidentally, it has been described that the public key certificate is issued when the verifications of the certificate signing request and the access token are successful. However, the certificate issuing module 30i may issue the public key certificate, based on the issuance history information (i.e., a history of public key certificates issued in the past) managed by the issuance history management module 30j.

FIG. 14 shows an example of the issuance history information. As shown in FIG. 14, the issuance history information includes the public keys for which the public key certificates have been issued in the past, attribute information for the public key certificates, the user ID for identifying the users who have requested the issuance of the public key certificates, and the date and time (issuance date and time) when the public key certificates were issued. Incidentally, the attribute information includes, for example, information for identifying the edge device 10, and the like.

According to the issuance history information shown in FIG. 14, the certificate issuing module 30i can confirm whether or not a certificate for the same public key as the public key for which the issuance of the public key certificate is requested by the certificate signing request has been issued in the past (in other words, whether or not the issuance history information including the same public key and attribute information as the certificate signing request, is already managed by the issuance history management module 30j), by referring to the issuance history information. More specifically, for example, if the certificate signing request includes the date and time when the certificate signing request was generated (hereinafter referred to as request generation date and time), in a case where the public key and the attribute information included in the issuance history information including the issuance date and time before the request generation date and time, match the public key and the attribute information included in the certificate signing request, it can be confirmed that the certificate for the same public key has been issued in the past.

If it is confirmed that the certificate for the same public key has been issued in the past, the certificate issuing module 30i may not issue a public key certificate in response to the certificate signing request, but may discard the certificate signing request. In this case, the certificate issuing module 30i may notify the edge device 10 via the second communication module 30b that the certificate signing request has been discarded or may notify the administrator of the certificate authority 30 of the alert.

It has been described that a public key certificate is not issued if the certificate for the same public key has already been issued. For example, however, a public key certificate for the same public key can be re-issued by embedding the serial number of the public key certificate or a random number in the attribute information (in other words, making the attribute information different by the serial number or random number).

When receiving the public key certificate and the user-specified information sent from the certificate authority 30 in step S11, the registration module 10h included in the edge device 10 registers the public key certificate in the edge device 10. Incidentally, the user-specified information may be managed (set) in the edge device 10 (for example, the device information management module 10d or the like). The initial settings of the edge device 10 are thereby completed.

When the public key certificate is registered in the edge device 10 as described above, the device authentication process using the public key certificate is executed between the edge device 10 and the application server device 40 (step S12). Incidentally, in step S12, for example, the device authentication process for confirming whether the public key certificate presented by the edge device 10 is a public key certificate legitimately issued for the public key of the edge device 10 may be executed.

If the edge device 12 is authenticated by the execution of the process in step S10, the application processing part 10i included in the edge device 10 starts execution of the application communication with the application server device 40 (step S13). Providing the IoT services is achieved by the edge device 10 and the application server device 40 operating in cooperation as an application system via such application communication.

Although detailed descriptions referring to FIG. 9 are omitted, for example, the electronic signature generated using the private key of the edge device 10 may be attached to the certificate signing request sent from the edge device 10 to the certificate authority 30. When the electronic signature is thus attached to the certificate signing request, verification of the certificate signing request using the electronic signature can be executed.

Similarly, the electronic signature generated using the private key of the certificate authority 30 may be attached to the public key certificate sent from the certificate authority 30 to the edge device 10. If the electronic signature is thus attached to the public key certificate, verification of the public key certificate using the electronic signature can be executed.

As described above, the communication system 1 of the embodiment sends the device authorization request and the device information from the edge device 10 (communication device) to the certificate authority 30, and sends the verification URL (i.e., access information for accessing the certificate authority 30), and the user code and the device code which are managed in association with the device information, from the certificate authority 30 to the edge device 10 in response to the device authorization request. In addition, the communication system 1 sends the verification URL and the user code from the edge device 10 to the user terminal 20 (terminal device), sends the user code from the user terminal 20 to the certificate authority by the user terminal 20 accessing the certificate authority 30 based on the verification URL, sends the device information managed in association with the user code from the certificate authority 30 to the user terminal 20. Furthermore, the communication system 1 requests issuance of an access token by sending the user code from the user terminal 20 to the certificate authority 30 based on the device information, and issues the access token managed in association with the user code at the certificate authority 30, based on the request from the user terminal 20. In addition, the communication system 1 requests acquisition of an access token by sending the device code from the edge device 10 to the certificate authority 30, and sends the access token managed in association with the device code from the certificate authority 30 to the edge device 10, based on the request from the edge device 10. Furthermore, the communication system 1 sends the certificate signing request and the access token from the edge device 10 to the certificate authority 30, and issues the public key certificate at the certificate authority 30, based on the certificate signing request and the access token.

In the embodiment, with the above-described configuration, the public key certificate for the edge device 10 in the factory default state (i.e., the public key certificate used by the edge device 10 for communication) can easily be issued.

In addition, for example, in the configuration of merely issuing the public key certificate between the edge device 10 and the certificate authority 30, it is difficult for the certificate authority 30 to determine whether or not the certificate can be issued. In the embodiment, however, issuing an appropriate public key certificate can be realized by using the user terminal 20 (i.e., by the user instructing the issuance of a public key certificate).

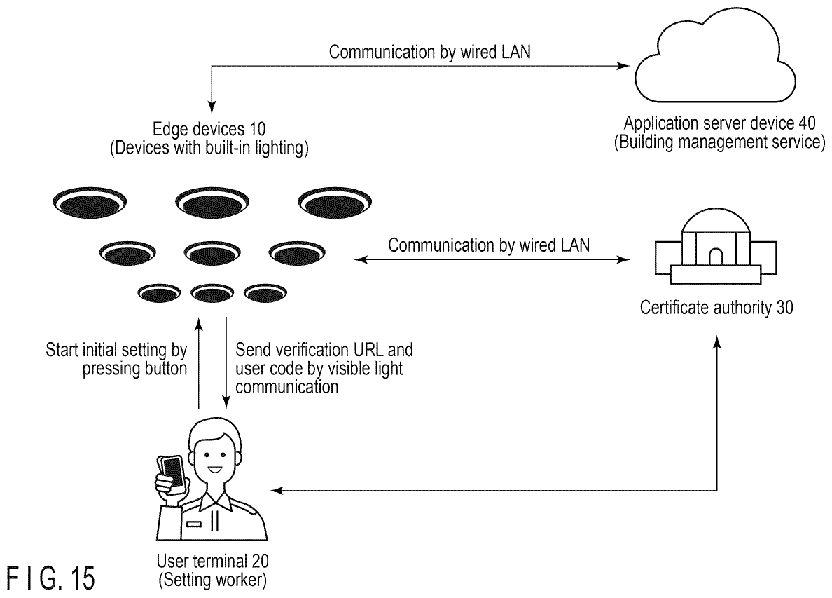

An example of specific usage of the communication system 1 according to the embodiment will be described with reference to FIG. 15.

In FIG. 15, it is assumed that devices with built-in lighting are used as the edge devices 10. The devices with built-in lighting are devices which are built in the lighting equipment installed in a building (facility). Each device with built-in lighting includes sensors which output various types of sensor data. The sensors may be, for example, measurement sensors which measure data such as temperature, humidity, illuminance, carbon dioxide concentration, or vibration, or may be image sensors which capture images. In addition, the device with built-in lighting includes, for example, a function of controlling facility devices in the building. The facility devices controlled by the devices with built-in lighting may be lighting facilities incorporating the devices with built-in lighting or may be air conditioning facilities installed in the building.

The devices with built-in lighting send the sensor data (measurement data) output from the sensors provided in the devices with built-in lighting to the application server device 40 which provides the building management service. The building management service enables the building environment to be maintained appropriately by analyzing the sensor data sent from each device with built-in lighting, and controlling the facility devices in the building, using the device with built-in lighting, based on the analysis results. Incidentally, it is assumed that communication between the device with built-in lighting and the building management service is executed via, for example, wired LAN arranged inside the building.

In order for the devices with built-in lighting and the building management service to execute communication as described above, the public key certificate of each device with built-in lighting is required. In order to issue the public key certificate of the device with built-in lighting, the setting worker who uses the user terminal 20 executes the initial setting work after the device with built-in lighting is installed in the building at the same time as the lighting facilities by a building construction contractor.

The above initial setting work will be described in more detail. First, the setting worker presses a specified button on the lighting facilities. The device with built-in lighting thereby sends the device authorization request to the certificate authority 30. The certificate authority 30 responds to the device authorization request sent from the device with built-in lighting and returns the verification URL, the user code, and the device code to the device with built-in lighting. Incidentally, it is assumed that communication between the device with built-in lighting and the certificate authority 30 is executed via, for example, wired LAN.

Next, the verification URL and the user code need to be sent (transmitted) from the device with built-in lighting to the user terminal 200 and, in this case, visible light communication is used. In this case, visible light communication is realized by encoding the data obtained by combining the verification URL and the user code into the flickering timing of the lighting equipment, and controlling (turning on and off) the lighting facilities according to the flickering timing.

The user terminal 20 (for example, smartphone) used by the setting worker acquires (receives) the verification URL and the user code sent (transmitted) from the lighting facilities by visible light communication. Furthermore, the user terminal 20 can execute communication with the certificate authority 30 by accessing the acquired verification URL. Incidentally, the communication between the user terminal 20 and the certificate authority 30 is executed via, for example, a mobile phone line.

In this case, the user terminal 20 sends the access token issuance request and the user-specified information to the certificate authority 30. The user-specified information may be, for example, location information for the lighting facilities (i.e., the names of the building, floor, and room, the serial numbers of the lighting positions, and the like).

Detailed descriptions are omitted below but, after the access token issued by the certificate authority 30 is acquired by the device with built-in lighting, the public key certificate of the device with built-in lighting is issued at the certificate authority 30 by sending the certificate signing request from the device with built-in lighting to the certificate authority 30.

In the embodiment, it is possible to easily issue individual public key certificates for the devices with built-in lighting by, for example, utilizing the communication system 1 as shown in FIG. 15.

In addition, in the example shown in FIG. 15, since the devices with built-in lighting execute the processing on the initial settings (initialization setting sequence) using the wired LAN and visible light communication, it is unnecessary to install dedicated communication means for initial settings (for example, a function of executing communication based on Bluetooth, or the like), and it is possible to reduce the costs of the devices with built-in lighting (edge devices 10) and the user terminal 20.

Incidentally, for example, in the case where the device with built-in lighting incorporates a small display, the verification URL and the user code may be transmitted from the device with built-in lighting to the user terminal 20 by reading the QR code (i.e., a two-dimensional code in which the verification URL and the user code are encoded) displayed on the display using the user terminal 20 (camera).

In other words, in the embodiment, if the edge device 10 and the user terminal 20 are configured so as to able to send (transmit) the verification URL and the user code described above between the edge device 10 and the user terminal 20, the initial settings for issuing the certificate can be realized. For example, even if the edge device 10 and the user terminal 20 include functions of realizing the above-described communication based on Bluetooth, the processing on the initial settings described in the embodiment (i.e., the processing shown in FIG. 9) may be executed. In such a configuration, the amount of communication between the edge device 10 and user terminal 20 can be reduced.

Incidentally, in the embodiment, it is possible to issue a public key certificate in response to a request from a legitimate user, by the configuration of determining whether or not the user using the user terminal 20 has the authority to issue a public key certificate for the edge device 10, based on the device information managed in association with the user code sent from the user terminal 20 to the certificate authority 30 and the verification information prepared in advance.

In addition, in the embodiment, the user terminal 20 presents the device information sent from the certificate authority 30 to the user using the user terminal 20, and the access token issuance request is sent from the user terminal 20 to the certificate authority 30 in accordance with the instructions of the user to whom the device information is presented. According to such a configuration, it is possible to prevent the public key certificate for the edge device 10 which the user does not intend from being issued.

Furthermore, in the embodiment, when the user-specified information is sent from the user terminal 20 to the certificate authority 30 together with the access token issuance request and when the public key certificate is issued, the user-specified information is sent from the certificate authority 30 to the edge device 10 together with the public key certificate. According to such a configuration, it is possible to easily set the information specified by the user in the edge device 10 together with the public key certificate.

It has been described that the user-specified information is sent from the certificate authority 30 to the edge device 10 together with the public key certificate. However, the information sent together with the public key certificate may be some parts of the user-specified information or may include some or all parts of the device information. Furthermore, the public key certificate including some or all parts of the device information and user-specified information described above may be sent from the certificate authority 30 to the edge device 10.

In addition, the user-specified information may be input (specified) on the screen where the above-described device information is displayed, by the user. According to this, the information which the user intends can be registered in the edge device 10.

The embodiment may be configured to enable the issuance of the public key certificate for the edge device 10 in the factory default state to be realized using user terminals 20. For example, the communication system 1, the edge device 10, the user terminal 20, and the certificate authority 30 described above in the embodiment may have some of their components omitted or other components may be added.

### Second Embodiment

Next, a second embodiment will be described. In the embodiment, detailed descriptions of the portions like or similar to the above-described first embodiment are omitted and the portions different from those of the first embodiment will be mainly described.

In the above-described first embodiment, the edge device sends a device authorization request to the certificate authority in the process on initial settings (initial setting sequence). However, if no direct trust is established between the edge device and the certificate authority in advance, for example, the edge device may send false device information along with the device authorization request. In this case, the certificate authority may issue a certificate for the edge device for which a certificate should not be issued based on the false device information.

This embodiment is different from the above-described first embodiment in that, in consideration of the above circumstances, the certificate authority verifies that the device information sent from the edge device is legitimate (i.e., the authenticity of the device information) using the method of configuration certification.

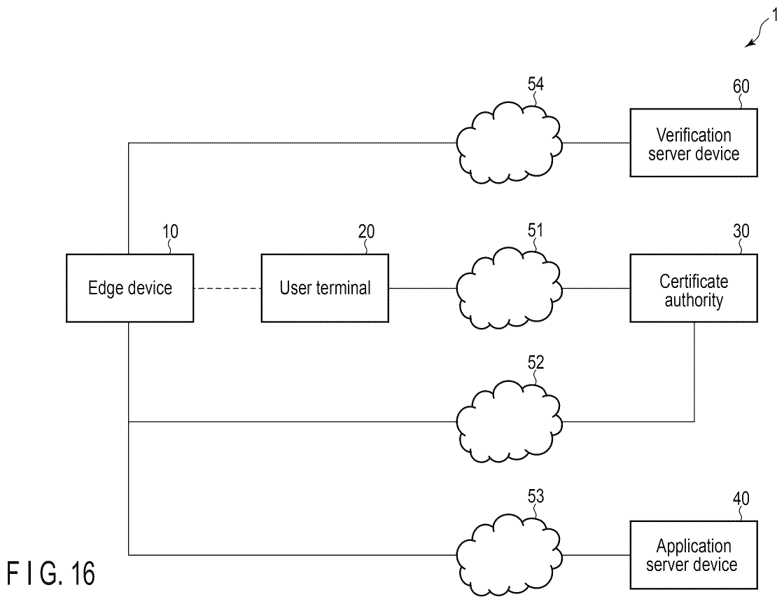

FIG. 16 shows an example of a system configuration of a communication system according to the embodiment. Incidentally, in FIG. 16, portions like or similar to those shown in FIG. 1 are denoted by the same reference numbers and symbols, and their detailed explanations are omitted.

As shown in FIG. 16, the communication system 1 of the embodiment further includes a verification server device 60 that is different from the application server device 40 in comparison with the above-described first embodiment.

The verification server device 60 is connected communicably with the edge device 10 via a network 54 and is configured to execute a process of verifying the authenticity of the above-described device information.

Incidentally, for example, the verification server device 60 may be connected communicably with the edge device 10 via a network 52, 53, or the like.

In addition, the entity operating the verification server device 60 may be the same as or different from the certificate authority 30. More specifically, for example, the verification server device 60 may be operated by the manufacturer of the edge device 10.

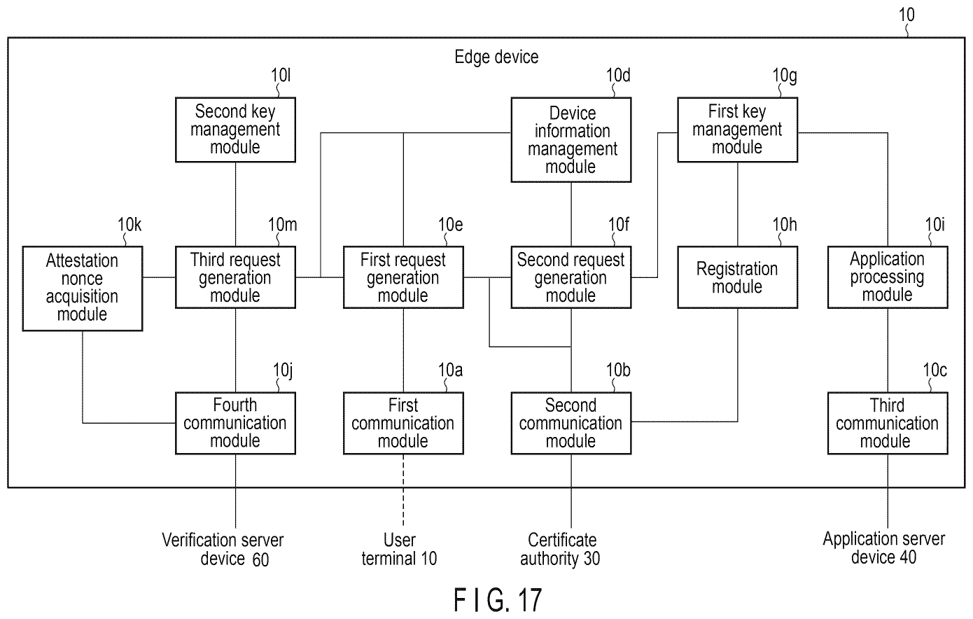

FIG. 17 shows an example of a functional configuration of the edge device 10 according to the embodiment. In FIG. 17, portions like or similar to those shown in FIG. 2 are denoted by the same reference numerals and their detailed explanations are omitted.

As shown in FIG. 17, the edge device 10 further includes a fourth communication module 10j, an attestation nonce acquisition module 10k, a second key management module 10l, and a third request generation module 10m, in comparison with the above-described first embodiment. Incidentally, the above-described key management module 10g shown in FIG. 4 is shown as the first key management module 10g for convenience for distinction from the second key management module 10l, in FIG. 17.

In addition, the fourth communication module 10j executes communication with the verification server device 60 via the network 54. Incidentally, in FIG. 17, the fourth communication module 10j is shown as a functional module separated from the first communication module 10a, the second communication module 10b, and the third communication module 10c. However, the fourth communication module 10j may be realized as the same functional module as at least one of the first communication module 10a, the second communication module 10b, and the third communication module 10c. In addition, the communication method used by the fourth communication module 20j to execute communication may be different from or the same as the communication method used by the first communication module 10a to execute communication, the communication method used by the second communication module 10b to execute communication, and the communication method used by the third communication module 10c to execute communication.

The attestation nonce acquisition module 10k requests the verification server device 60 to issue an attestation nonce via the fourth communication module 10j, and acquires (receives) the attestation nonce sent from the verification server device 60 in response to the request. Incidentally, the attestation nonce is a random number that is used only once (for example, a discarded random character string). The attestation nonce acquired by the attestation nonce acquisition module 20k is delivered from the attestation nonce acquisition module 10k to the third request generation module 10m.

The second key management module 10l manages the public key and the private key for proving that the edge device 10 is a legitimate or trustworthy device in the embodiment (i.e., public and private keys for attestation). Incidentally, this pair of public and private keys for attestation (asymmetric encryption key pair) is referred to as attestation keys. The attestation keys are generated by the manufacturer of the edge device 10 and written to the second key management module 10l at the time of manufacturing the edge device 10 (in other words, held in advance in the edge device 10). In addition, the second key management module 10l manages the key ID (hereinafter referred to as an attestation key ID) for identifying the attestation keys (i.e., the pair of public and private keys for attestation).

The third request generation module 10m generates an electronic signature using the attestation key (the private key for attestation) for the device information (i.e., information such as manufacturer, model, and serial number) and (the data including) the attestation nonce managed by the device information management module 10d. In the following descriptions, this electronic signature is referred to as an attestation signature.

The third request generation module 10m generates the device information, the attestation nonce, and a verification request which includes the attestation signature, and the attestation key ID. The verification request generated by the third request generation module 10m is sent from the fourth communication module 10j to the verification server device 60.

Incidentally, the above-described second key management module 10l is assumed to be, in principle, located in hardware whose data cannot be read from or written to the outside (other than the third request generation module 10m). In other words, in the embodiment, the attestation key is assumed to be managed to be used by only the third request generation module 10m (i.e., only the third request generation module 10m can generate the attestation signature).

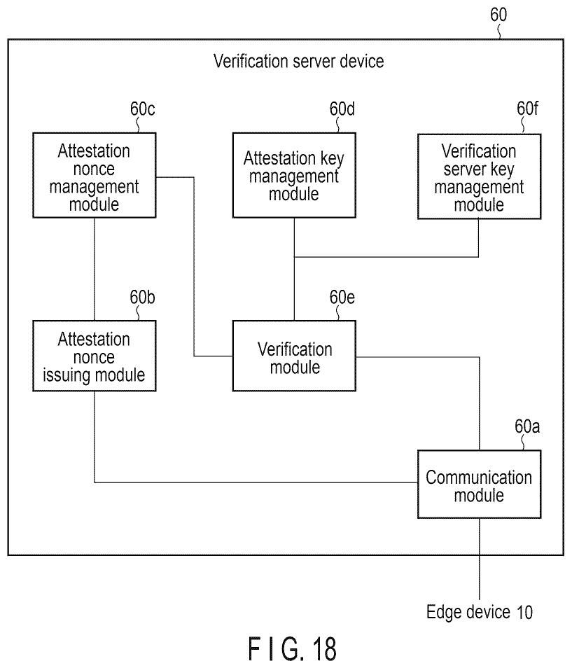

FIG. 18 shows an example of a functional configuration of the verification server device 60 shown in FIG. 16. As shown in FIG. 18, the verification server device 60 includes a communication module 60a, an attestation nonce issuing module 60b, an attestation nonce management module 60c, an attestation key management module 60d, a verification module 60e, and a verification server key management module 60f.

The communication module 60a executes communication with the edge device 10 via the network 54. The attestation nonce issuing module 60b accepts a request (i.e., an attestation nonce issuance request) from the edge device 10 via the communication module 60a and issues (generates) an attestation nonce. Incidentally, the attestation nonce issuing module 60b issues an attestation nonce with a value which is different for each edge device 10 which is the source of the attestation nonce issuing request.

The attestation nonce issued by the attestation nonce issuing module 60b is sent to the edge device 10 via the communication module 60a, and is delivered to the attestation nonce management module 60c.

The attestation nonce management module 60c manages the validity period of the attestation nonce in association with the attestation nonce delivered from the attestation nonce issuing module 60b.

The attestation key management module 60d manages the attestation key (in particular, the public key for the attestation) in association with the above-described attestation key ID.

The verification module 60e acquires (receives) the verification request sent from the edge device 10 via the communication module 60a. The verification module 60e executes verifications of the attestation nonce and the attestation signature included in the verification request. In this case, the verification module 60e refers to the information managed by the attestation nonce management module 60c and the attestation key management module 60d.

The verification server key management module 60f manages the private key and public key (key pair) of the verification server device 60 in the public key cryptography. The private key of the verification server device 60 managed by the verification server key management module 60f is used to generate an electronic signature attached to the verification result of the above-described verification module 60e.

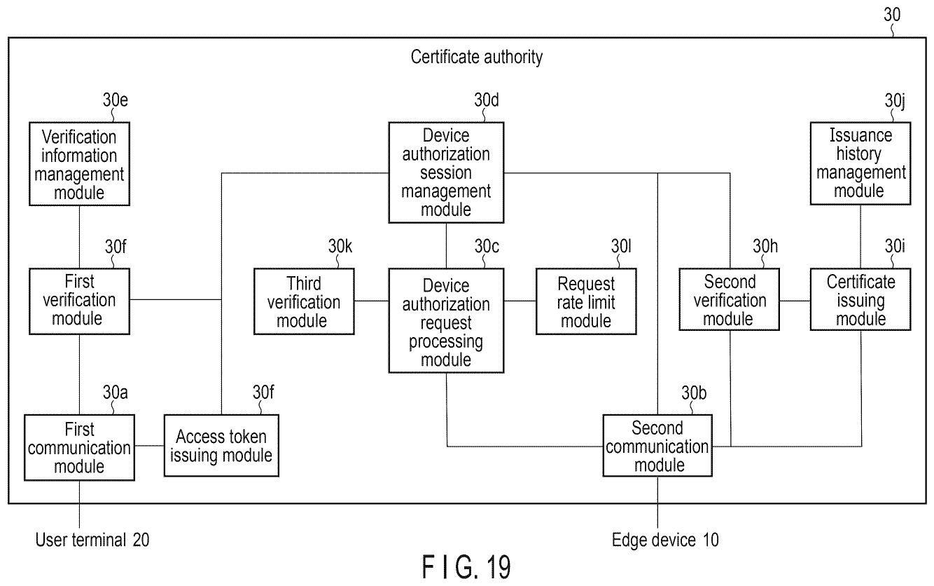

FIG. 19 shows an example of a functional configuration of the certificate authority 30 according to the embodiment. In FIG. 19, portions like or similar to those shown in FIG. 7 are denoted by the same reference numerals and their detailed explanations are omitted.

As shown in FIG. 19, the certificate authority 30 further includes a third verification module 30k and a request rate limit module 30l in comparison with the above-described first embodiment.

The verification results from the verification server device 60 in the embodiment are sent from the verification server device 60 to the edge device 10, and are also sent (transferred) from the edge device 10 to the certificate authority 30. The third verification module 30k executes the verification of the verification results from the verification server device 60. Incidentally, the public key of the verification server device 60 is assumed to be held (shared) in advance in the third verification module 30k, and verifying the verification results by the third verification module 30k is executed using the public key of the verification server device 60.

The request rate limit module 30l monitors the frequency (receiving frequency) of device authorization requests from the edge device 10, and restricts the acceptance of the device authorization requests based on the monitoring results.

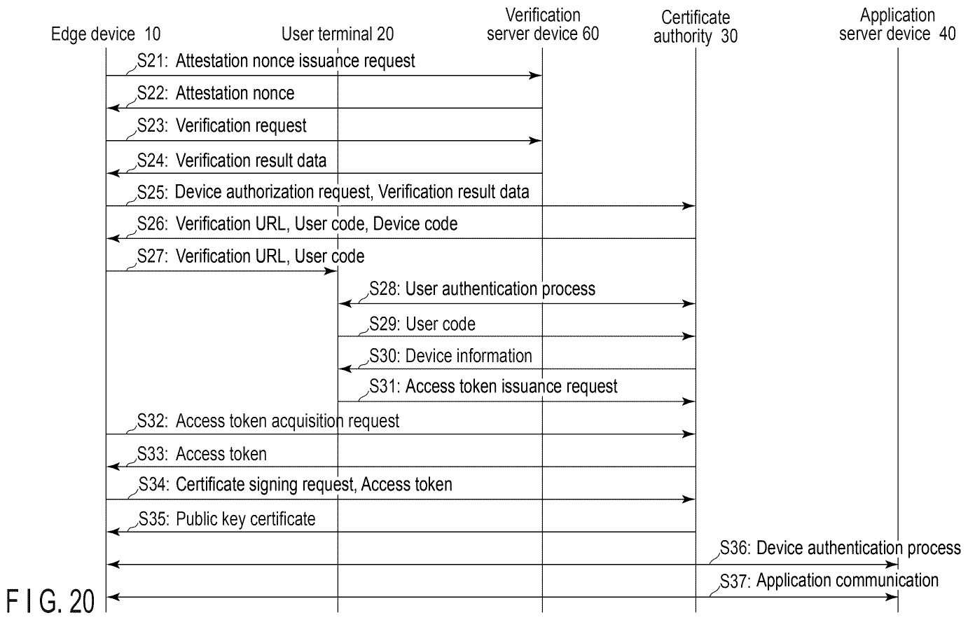

An example of the procedure of the communication system 1 according to the embodiment will be described below with reference to a sequence chart of FIG. 20.

First, the attestation nonce acquisition module 10k included in the edge device 10 requests the server device 60 to issue the attestation nonce via the fourth communication module 10j. In this case, the attestation nonce issuance request is sent from the fourth communication module 10j to the verification server device 60 (step S21).

The attestation nonce issuing module 60b included in the verification server device 60 accepts the attestation nonce issuance request sent in step S21 via the communication module 60a. The attestation nonce issuing module 60b issues the attestation nonce in response to the accepted attestation nonce issuance request. The attestation nonce issued by the attestation nonce issuing module 60b is sent from the communication module 60a to the edge device 10 (step S22). Incidentally, the attestation nonce management module 60c manages the attestation nonce issued by the attestation nonce issuing module 60b (i.e., the attestation nonce sent to the edge device 10) together with the validity period set for the attestation nonce. In this case, the time can be set to the time after a specified period of time has elapsed from the time when the attestation nonce is issued (for example, one minute later), as the validity period.

The above-described attestation nonce sent in step S22 is acquired by the attestation nonce acquisition module 10k via the fourth communication module 10j. The attestation nonce acquired by the attestation nonce acquisition module 10k is delivered from the attestation nonce acquisition module 10k to the third request generation module 10m.

In the embodiment, the verification request is generated by the third request generation module 10m before sending the device authorization request described in the first embodiment. In this case, the third request generation module 10m acquires the device information managed by the device information management module 10d from the device information management module 10d, and acquires the attestation key ID and the attestation key managed by the second key management module 10l from the second key management module 10l. The third request generation module 10m generate the attestation signature for the device information acquired from the device information management module 10d and the attestation nonce delivered from the attestation nonce acquisition module 10k, using the attestation key acquired from the second key management module 10l. The attestation signature corresponds to an electronic signature using the attestation key for the device information and attestation nonce. The attestation signature is generated by, for example, executing a cryptographic process using the attestation key (attestation private key) on the hash value of the device information and attestation nonce. The attestation signature thus generated is used to secure the authenticity of the device information.

The third request generation module 10m generates the device information, the attestation nonce, and a verification request which includes the attestation signature, and the attestation key ID. The verification request thus generated by the third request generation module 10m is sent from the fourth communication module 10j to the verification server device 60 (step S23).

When receiving the verification request sent from the edge device 10 in step S23, the verification module 60e included in the verification server device 60 executes verification of the contents of the verification request (for example, the attestation nonce and the attestation signature).

More specifically, for example, if the attestation nonce issued by the attestation nonce issuing module 60b is managed by the attestation nonce management module 60c in association with its validity period, the verification module 60e confirms whether the attestation nonce included in the verification request is managed by the attestation nonce management module 60c and whether or not the attestation nonce is valid (i.e., whether or not the validity period of the attestation nonce has not expired). This verification of the attestation nonce is successful if the attestation nonce included in the verification request is managed by the attestation nonce management module 60c and if the attestation nonce is valid.

In addition, for example, if the attestation key (public key for attestation) is managed in association with the attestation key ID by the attestation key management module 60d, the verification module 60e acquires the public key for attestation managed by the attestation key management module 60d in association with the attestation key ID included in the verification request, and verifies the attestation signature included in the verification request using the acquired public key for attestation. In this case, the verification module 60e executes a process of calculating hash values of the device information and the attestation nonce included in the verification request, and collating the calculated hash values with the result (hash value) obtained by encrypting the attestation signature included in the certificate signing request with the public key for attestation. The verification of the attestation signature is successful if the hash values of the device information and the attestation nonce match the hash value obtained from the attestation signature.

If the verifications of the attestation nonce and the attestation signature are successful, the verification module 60e acquires the private key of the verification server device 60 managed by the verification server key management module 60f, and generates an electronic signature using the private key of the verification server device 60 for the entire data including the device information and the attestation nonce. Incidentally, this electronic signature is generated by executing the cryptographic process using the private key of the verification server device 60 for the hash values of the device information and the attestation nonce. The data including the device information, the attestation nonce, and the electronic signature (hereinafter referred to as verification result data) is sent from the communication module 60a to the edge device 10 (step S24).

When receiving the verification result data sent from the verification server device 60 in step S24, the third request generation module 10m included in the edge device 10 delivers the verification result data to the first request generation module 10e.

The first request generation module 10e generates a device authorization request. Since the device authorization request generated by the first request generation module 10e is the same as that of the above-described first embodiment, its detailed descriptions are omitted here.

In the embodiment, the device authorization request generated by the first request generation module 10e and the verification result data delivered from the third request generation module 10m to the first request generation module 10e are sent from the second communication module 10b to the certification authority 30 (step S25).

When receiving the device authorization request and the verification result data sent from the edge device 10 in step S25, the device authorization request processing module 30c included in the certificate authority 30 delivers the verification result data to the third verification module 30k.

The third verification module 30k executes verification of the verification result data delivered from the device authorization request processing module 30c. More specifically, if the third verification module 30k is assumed to hold the public key of the verification server device 60 (i.e., the public key paired with the private key of the verification server device 60) in advance, the third verification module 30k executes verification of the electronic signature included in the verification result data, using the public key of the verification server device 60. In the verification of the electronic signature, a process of calculating hash values of the device information and the attestation nonce included in the verification result data, and collating the calculated hash values with the result (hash value) obtained by encrypting the electronic signature included in the verification result data with the public key of the verification server device 60, is executed. The verification of the electronic signature is successful if the hash values of the device information and the attestation nonce included in the verification result data match the hash value obtained from the electronic signature.

Incidentally, if the verification of the electronic signature fails, an error is returned from the certification authority 30 to the edge device 10.

In the embodiment, as described above, the authenticity of the device information can be verified using the attestation nonce. For example, however, if a malicious user sends a large number of device authorization requests from multiple edge devices 10 to the certification authority 30, the resource (for example, communication bandwidth, computing power, storage space or the like) of the certification authority 30 may be consumed, causing the service of the certification authority 30 to stop.

For this reason, the request rate limit module 30l confirms the frequency of the device authorization requests sent from the edge device 10 (i.e., acquired by the device authorization request processing module 30c), and restricts the acceptance of device authorization requests according to the frequency of the device authorization requests (i.e., determines possibility of the acceptance). In this case, for example, the request rate limit module 30l aggregates (the count of) device authorization requests acquired by the device authorization request processing module 30c, and determines whether or not the frequency of the device authorization requests exceeds the upper limit.

More specifically, the device authorization request processing module 30c permits the acceptance of the device authorization requests if the frequency of the device authorization requests is lower than or equal to the upper limit value or rejects the acceptance of the device authorization requests if the frequency of the device authorization requests exceeds the upper limit value.

Incidentally, various possible methods of aggregating the device authorization requests are conceived. For example, the device information included in the verification result data sent from the edge device 10 together with the device authorization requests is referenced and, if all or some parts of the manufacturers, models, and serial numbers included in the device information match, the device authorization requests are aggregated as the device authorization requests from the same edge device 10. In this case, the value obtained by dividing the number of device authorization requests thus aggregated by a certain time interval may be taken as the frequency of the device authorization requests, and the frequency of the device authorization requests may be compared with the upper limit value.

In addition, the upper limit value compared with the frequency of the device authorization requests may be set (managed), and different values may also be set (managed) based on all or some parts of the manufacturers, models, and serial numbers (i.e., according to the aggregation unit of the device authorization requests).

If the verification of the electronic signature included in the above-described verification result data is successful and if the acceptance of the device authorization request is permitted, the device authorization request processing module 30c issues the verification URL, the user code, and the device code as described above in the first embodiment.

If the verification of the electronic signature included in the verification result data fails or if the acceptance of the device authorization request is rejected, the device authorization request is discarded and an error is returned to the edge device 10.

After the verification URL, the user code, and the device code are issued by the device authorization request processing module 30c as described above, processes in steps S26 to S37 corresponding to the above-described processes in steps S2 to S13 shown in FIG. 9 are executed.

As described above, in the embodiment, it is possible to easily issue the public key certificate for the edge device 10 in its factory default state, similarly to the above-described first embodiment, and to realize a communication system 1 of high reliability by executing the verifications of the attestation nonce and the attestation signature.

Furthermore, in the embodiment, it is possible to avoid the situation where the services of the certification authority 30 are stopped by malicious users, by restricting the acceptance of the device authorization requests based on the result of determining whether or not the frequency of the device authorization requests exceeds the upper limit value, and to realize a communication system 1 of higher reliability.

Incidentally, it has been described that in the embodiment, the device authorization request is discarded if the verification of the electronic signature included in the verification result data fails. For example, however, if the verification of the electronic signature included in the verification result data fails (i.e., if the verification result data is not legitimate), possibility of acceptance of the device authorization request may be determined by lowering the upper limit value compared to the frequency of the device authorization requests (i.e., imposing a strict reception frequency limit on the device authorization request). In addition, if the verification of the electronic signature included in the verification result data is successful (i.e., if the verification result data is legitimate), the device authorization request may be accepted unconditionally without determining the possibility of acceptance of the device authorization request (i.e., without imposing a reception frequency limit on the device authorization request). In other words, in the embodiment, the upper limit value compared to the frequency of the device authorization requests may be varied based on, for example, the verification result of the electronic signature included in the verification result data.

In addition, it has been described that the verification server device 60 executes the verifications of the attestation nonce and the attestation signature in the embodiment. However, at least some of the processes described as being performed by the verification server device 60 may be executed by the certificate authority 30 or other devices.

According to at least one of the above-described embodiments, a communication system, a terminal device, a communication device, a certificate authority, and a method capable of easily executing issuance of a certificate used for communication can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication system comprising a communication device, a terminal device, and a certificate authority, wherein
the communication device is configured to send a device authorization request requesting authorization of the communication device and device information on the communication device to the certificate authority;
the certificate authority is configured to send access information for accessing the certificate authority, and a user code and a device code managed in association with the device information, to the communication device, in response to the device authorization request;
the communication device is configured to send the access information and the user code to the terminal device;
the terminal device is configured to send the user code to the certificate authority by accessing the certificate authority based on the access information;
the certificate authority is configured to send the device information managed in association with the user code to the terminal device;
the terminal device is configured to request issuance of an access token by sending the user code to the certificate authority, based on the device information;
the certificate authority is configured to issue an access token managed in association with the user code, in response to the request from the terminal device;
the communication device is configured to request acquisition of an access token by sending the device code to the certificate authority;
the certificate authority is configured to send an access token managed in association with the device code to the communication device, in response to the request from the communication device;
the communication device is configured to send a certificate signing request for requesting issuance of a certificate used to execute communication with an application server device and the access token to the certificate authority; and
the certificate authority is configured to issue the certificate based on the certificate signing request and the access token.

2. The communication system of claim 1, wherein
the certificate authority is configured to determine whether a user using the terminal device has an authority to issue the certificate, based on device information managed in association with the user code sent from the terminal device to the certificate authority and verification information prepared in advance.

3. The communication system of claim 1, wherein
the terminal device is configured to present device information sent from the certificate authority to the terminal device, to a user using the terminal device, and
the terminal device is configured to request issuance of the access token in accordance with an instruction of the user to which the device information is presented.

4. The communication system of claim 3, wherein
the terminal device is configured to send user-specified information designated by the user using the terminal device to the certificate authority when requesting the issuance of the access token, and
the certificate authority is configured to send some or all parts of the device information and the user-specified information to the communication device together with the issued certificate when the certificate is issued.

5. The communication system of claim 3, wherein
the terminal device is configured to send user-specified information designated by the user using the terminal device to the certificate authority when requesting the issuance of the access token, and
the certificate authority is configured to send the certificate including some or all parts of the device information and the user-specified information to the communication device when the certificate is issued.

6. The communication system of claim 4, wherein
the user-specified information is input on a screen on which the device information is presented, by the user.

7. The communication system of claim 1, further comprising:
a verifying server device, wherein
the communication device is configured to send a verification request which includes the device information, an attestation nonce, and an electronic signature generated using a private key for attestation held in advance in the communication device for the device information and the attestation nonce, to the verifying server device,
the verifying server device is configured to execute verification of the electronic signature included in the verification request, using a public key for attestation which is paired with the private key for attestation, and
the certificate authority is configured to issue the certificate, based on a result of the verification.

8. The communication system of claim 1, wherein
the certificate authority is configured to restrict acceptance of the device authorization request, based on a determination result on whether frequency of the device authorization request sent from the communication device exceed an upper limit value.

9. The communication system of claim 8, wherein
the certificate authority is configured to manage the upper limit value in association with the device information and sum the frequency of the device authorization request sent from the communication device specified by the device information.

10. The communication system of claim 1, wherein
an authentication process for the user using the terminal device is executed between the terminal device and the certificate authority, and
the terminal device is configured to send the user code when the user is authorized by executing the authentication process.

11. A terminal device used to issue a certificate for a communication device to execute communication with an application server device, the terminal device comprising a processor configured to:
when a device authorization request requesting authorization of the communication device and device information on the communication device are sent from the communication device to a certificate authority such that access information for accessing the certificate authority, and a user code and a device code managed in association with the device information are sent from the certificate authority to the communication device, receive the access information and the user code from the communication device;
send the user code to the certificate authority by accessing the certificate authority based on the access information;
receive the device information managed in association with the user code from the certificate authority; and
request issuance of an access token by sending the user code to the certificate authority, based on the device information, wherein
the certificate authority is configured to issue the access token managed in association with the user code, in response to the request from the terminal device,
the communication device is configured to request acquisition of the access token by sending the device code to the certificate authority,
the certificate authority is configured to send the access token managed in association with the device code to the communication device, in response to the request from the communication device,
the communication device is configured to send a certificate signing request requesting issuance of the certificate, and the access token, to the certificate authority, and
the certificate authority is configured to issue the certificate, based on the certificate signing request and the access token.

12. A communication device configured to execute communication with an application server device, the communication device comprising a processor configured to:
send a device authorization request requesting authorization of the communication device and device information on the communication device to a certificate authority;
when the device authorization request and the device information are sent from the communication device to the certificate authority, receive access information for accessing the certificate authority, and a user code and a device code managed in association with the device information, from the certificate authority;
send the access information and the user code to a terminal device;
receive an access token managed in association with the device code from the certificate authority, by sending the device code to the certificate authority and requesting acquisition of an access token; and
send a certificate signing request requesting issuance of a certificate used by the communication device to execute communication with the application server device, and the access token, to the certificate authority, wherein
the terminal device is configured to send the user code to the certificate authority by accessing the certificate authority based on the access information,
the certificate authority is configured to send the device information managed in association with the user code to the terminal device,
the terminal device is configured to request issuance of an access token by sending the user code to the certificate authority, based on the device information,
the access token is issued at the certificate authority in response to the request from the terminal device and managed in association with the user code, and
the certificate authority is configured to issue the certificate, based on the certificate signing request and the access token.

13. A certificate authority issuing a certificate used for a communication device to execute communication with an application server device, the certificate authority comprising a processor configured to:
receive a device authorization request requesting authorization of the communication device and device information on the communication device from the communication device;
send access information for accessing the certificate authority, and a user code and a device code managed in association with the device information, to the communication device, in response to the device authorization request;
send, to a terminal device, the device information managed in association with the user code sent by the terminal device accessing the certificate authority based on the access information sent from the communication device to the terminal device;
when issuance of an access token is requested by sending the user code from the terminal device based on the device information, issue an access token managed in association with the user code;
when acquisition of an access token is requested by sending the device code from the communication device, send an access token managed in association with the device code to the communication device;
receive a certificate signing request requesting issuance of the certificate, and the access token, from the communication device; and
issue the certificate, based on the certificate signing request and the access token.

14. A method executed by a communication system comprising a communication device, a terminal device, and a certificate authority, the method comprising:
sending a device authorization request requesting authorization of the communication device and device information on the communication device from the communication device to the certificate authority;
sending access information for accessing the certificate authority, and a user code and a device code managed in association with the device information, from the certificate authority to the communication device, in response to the device authorization request;
sending the access information and the user code from the communication device to the terminal device;
sending the user code from the terminal device to the certificate authority by the terminal device accessing the certificate authority based on the access information;
sending the device information managed in association with the user code from the certificate authority to the terminal device;
requesting issuance of an access token by sending the user code from the terminal device to the certificate authority, based on the device information;
issuing an access token managed in association with the user code at the terminal device, in response to the request from the terminal device;
requesting acquisition of an access token by sending the device code from the communication device to the certificate authority;
sending an access token managed in association with the device code from the certificate authority to the communication device, in response to the request from the communication device;
sending a certificate signing request for requesting issuance of a certificate used by the communication device to execute communication with an application server device and the access token from the communication device to the certificate authority; and
issuing the certificate at the certificate authority based on the certificate signing request and the access token.

15. A method executed by a terminal device used to issue a certificate for a communication device to execute communication with an application server device, the method comprising:
when a device authorization request requesting authorization of the communication device and device information on the communication device are sent from the communication device to a certificate authority such that access information for accessing the certificate authority, and a user code and a device code managed in association with the device information are sent from the certificate authority to the communication device, receiving the access information and the user code from the communication device;
sending the user code to the certificate authority by accessing the certificate authority based on the access information;
receiving the device information managed in association with the user code from the certificate authority; and
requesting issuance of an access token by sending the user code to the certificate authority, based on the device information, wherein
the certificate authority is configured to issue the access token managed in association with the user code, in response to the request from the terminal device,
the communication device is configured to request acquisition of the access token by sending the device code to the certificate authority,
the certificate authority is configured to send the access token managed in association with the device code to the communication device, in response to the request from the communication device,
the communication device is configured to send a certificate signing request requesting issuance of the certificate, and the access token, to the certificate authority, and
the certificate authority is configured to issue the certificate, based on the certificate signing request and the access token.

16. A method executed by a communication device configured to execute communication with an application server device, the method comprising:
sending a device authorization request requesting authorization of the communication device and device information on the communication device to a certificate authority;
when the device authorization request and the device information are sent from the communication device to the certificate authority, receiving access information for accessing the certificate authority, and a user code and a device code managed in association with the device information from the certificate authority;
sending the access information and the user code to a terminal device;
receiving an access token managed in association with the device code from the certificate authority, by sending the device code to the certificate authority and requesting acquisition of an access token; and
sending a certificate signing request requesting issuance of a certificate used by the communication device to execute communication with the application server device, and the access token, to the certificate authority, wherein
the terminal device is configured to send the user code to the certificate authority by accessing the certificate authority based on the access information,
the certificate authority is configured to send the device information managed in association with the user code to the terminal device,
the terminal device is configured to request issuance of an access token by sending the user code to the certificate authority, based on the device information,
the access token is issued at the certificate authority in response to the request from the terminal device and managed in association with the user code, and
the certificate authority is configured to issue the certificate, based on the certificate signing request and the access token.

17. A method executed by a certificate authority issuing a certificate used for a communication device to execute communication with an application server device, the method comprising:
receiving a device authorization request requesting authorization of the communication device and device information on the communication device from the communication device;
sending access information for accessing the certificate authority, and a user code and a device code managed in association with the device information, to the communication device, in response to the device authorization request;
sending, to a terminal device, the device information managed in association with the user code sent by the terminal device accessing the certificate authority based on the access information sent from the communication device to the terminal device;
when issuance of an access token is requested by sending the user code from the terminal device based on the device information, issuing an access token managed in association with the user code;
when acquisition of an access token is requested by sending the device code from the communication device, sending an access token managed in association with the device code to the communication device;
receiving a certificate signing request requesting issuance of the certificate, and the access token, from the communication device; and
issuing the certificate, based on the certificate signing request and the access token.
